(19) United States
(12) Patent Application Publication
(10) Pub. No.: US 2024/0259801 A1
(43) Pub. Date: Aug. 1, 2024

(54) RADIO DEVICES

(71) Applicant: Nordic Semiconductor ASA, Trondheim (NO)

(72) Inventor: Ravi Kiran BAMIDI, Trondheim (NO)

(73) Assignee: Nordic Semiconductor ASA, Trondheim (NO)

(21) Appl. No.: 18/428,465

(22) Filed: Jan. 31, 2024

(30) Foreign Application Priority Data
Feb. 1, 2023 (GB) 2301467.3

(51) Int. Cl. H04W 12/06

(52) U.S. Cl. CPC H04W 12/06

(57) ABSTRACT

A method of operating a client device is provided. The method comprises receiving a radio signal comprising an encrypted data packet, said data packet comprising one or more data structures addressed to one or more client devices; decrypting said data packet to obtain said one or more data structures; and establishing whether any of the one or more data structures is addressed to the client device. If a data structure of the data packet is addressed to the client device, the data packet is authenticated. If no data structure of the data packet is addressed to the client device, the data packet is discarded.

### CROSS REFERENCE TO RELATED APPLICATION

This application claims priority from Great Britain Application No. 2301467.3, filed Feb. 1, 2023, which application is incorporated herein by reference in its entirety.

### BACKGROUND OF THE INVENTION

The present invention relates to client devices and methods of operating client devices such as Electronic Shelf Labels.

Electronic Shelf Labels (ESLs) are widely used in retail stores to display information such as pricing about nearby products (e.g. products on a nearby shelf). The information is displayed electronically (e.g. using an electronic paper display) and can be updated remotely, for instance according to price changes made at a central server. ESLs can provide substantial advantages over traditional paper product labels, for instance reducing the labour involved in rolling-out price changes and reducing errors in displayed prices. The labels can easily be updated frequently and/or at short notice (e.g. to display limited-time offers) to improve customer engagement.

For convenience, many ESL systems use battery powered ESLs that use wireless communication protocols to receive commands such as pricing updates. Given that ESLs often display pricing information, it is important to maintain the security and integrity of the wireless communication using encryption and authentication. However, using encrypted communications may impose a larger processing burden on the ESLs, increasing energy use and reducing battery life. For instance, to decrypt and authenticate a message of length M octets encrypted with Advanced Encryption Standard—Counter with Cipher block Chaining Message authentication mode (AES-CCM) uses (┌M/16┐+1)×2 AES operations, requiring significant processing resources and associated energy use. An energy-efficient approach to wireless communication that can provide reliable and secure communication with radio devices such as ESLs may therefore be desired.

### SUMMARY OF THE INVENTION

According to a first aspect of the present invention there is provided a method of operating a client device, the method comprising:
receiving a radio signal comprising an encrypted data packet, said data packet comprising one or more data structures addressed to one or more client devices;
decrypting said data packet to obtain said one or more data structures;
establishing whether any of the one or more data structures is addressed to the client device; and
if a data structure of the data packet is addressed to the client device, authenticating the data packet; and
if no data structure of the data packet is addressed to the client device, discarding the data packet.

According to a second aspect of the present invention there is provided a client device arranged to:
receive a radio signal comprising an encrypted data packet, said data packet comprising one or more data structures addressed to one or more client devices;
decrypt said data packet to obtain said one or more data structures;
establish whether any of the one or more data structures is addressed to the client device; and
if a data structure of the data packet is addressed to the client device, authenticate the data packet; and
if no data structure of the data packet is addressed to the client device, discard the data packet.

According to a third aspect of the present invention there is provided a method of operating a radio communication system comprising a plurality of client devices and an access point, the method comprising:
the radio transceiver device transmitting a radio signal comprising an encrypted data packet, said data packet comprising one or more data structures addressed to one or more of the plurality of client devices; and
each of the plurality of client devices:
   receiving the radio signal comprising the encrypted data packet from the access point;
   decrypting said data packet to obtain said one or more data structures;
   establishing whether any of the one or more data structures is addressed to the client device; and
   if a data structure of the data packet is addressed to the client device, authenticating the data packet; and
   if no data structure of the data packet is addressed to the client device, discarding the data packet.

According to a fourth aspect of the present invention there is provided a radio communication system comprising:
a plurality of client devices; and an access point arranged to transmit a radio signal comprising an encrypted data packet, said data packet comprising one or more data structures addressed to one or more of the plurality of client devices;
wherein each of the plurality of client devices is arranged to:
receive the radio signal comprising the encrypted data packet from the access point;
decrypt said data packet to obtain said one or more data structures;
establish whether any of the one or more data structures is addressed to the client device; and
if a data structure of the data packet is addressed to the client device, authenticate the data packet; and
if no data structure of the data packet is addressed to the client device, discard the data packet.

Thus, as will be appreciated by those skilled in the art, by only authenticating the packet if it contains a data structure addressed to the client device (i.e. if the data packet concerns the client device) and discarding the data packet otherwise, the client device may perform fewer processing operations and thus consume less energy without sacrificing the security and integrity of data structures that are addressed to the client device.

In large networks, many data packets received by a given client device may not contain data structures addressed to that client device. As such, significant energy savings can be made by omitting authentication for these data packets. For instance, an Electronic Shelf Label (ESL) system in a supermarket may feature thousands of ESLs receiving data packets from one or more central access points, but a given data packet may contain commands addressed to only a small proportion of the ESLs (e.g. because only a limited number of ESLs require pricing updates at any one time). Processing efficiencies may be particularly advantageous in such systems because ESLs tend to be battery powered.

Because a client device only performs authentication if the packet concerns the client device, a compromised payload (e.g. as the result of a Man-in-the-Middle attack interfering with the integrity of the packet) may only be detected by client devices to which the contents of the packet is addressed. However, a reduced likelihood of detecting incorrectly authenticated packets may be acceptable in many implementations in exchange for reduced energy use. All packets addressed to a client device are still authenticated by that device, so there is no detriment in the integrity of packets that are actually processed by client devices.

In a set of embodiments, if authentication of the data packet succeeds, the client device proceeds to act on the data structure(s) of the data packet that are addressed to the client device. For instance, the client device may follow one or more commands contained in a data structure (e.g. to update information output to a display of the client device). Conversely, if authentication fails, the client device may discard the data packet.

The one or more data structures may contain any data suitable for addressing to a client device. In a set of embodiments, a data structure contains a command or a request for a client device, e.g. a command to change information displayed by the client device.

Each data structure of a data packet may be individually addressed to one or more client devices. For instance, each data structure may include address information which identifies one or more client devices to which said data structure is addressed (e.g. an address portion containing one or more client device addresses or identities). Establishing whether any of the one or more data structures is addressed to the client device may comprise the client device comparing the address information of each data structure in the data packet to address information of the client device. In some embodiments a data structure may include a broadcast address, indicating that the data structure is for all client devices in a broadcast group.

Additionally or alternatively, the data packet may include address information for a plurality of data structures contained therein. For instance, the data packet may include group address information (e.g. a group ID) which identifies a group of client devices to which data structure(s) of the data packet are addressed. Including group address information at a packet level may not be sufficient to definitively determine that there is one or more data structures addressed to a particular client device in the packet, but it may be sufficient to determine that there are no data structures addressed to a particular client device, if said client device is not in the identified group. For instance, the client device may be arranged to discard the packet immediately if it does not belong to the identified group (i.e. if the group address information indicates that the data packet contains only data structures addressed to client devices of a group to which the client device does not belong).

In a set of embodiments, the data packet is encrypted using symmetric encryption (i.e. in which the same key is used for encryption and decryption), i.e. such that decrypting the data packet comprises applying a symmetric-key algorithm to the data packet. The data packet may be encrypted using a block cipher. For instance, the data packet may be encrypted according to the Advanced Encryption Standard (AES), e.g. using AES-128. In some embodiments, the data packet is encrypted using counter mode operation (CTR), in which a successive values of a counter are used when encrypting successive blocks of the data packet. Decrypting an M-octet payload encrypted using counter mode AES requires ┌M/16┐ AES operations.

In some embodiments, the data packet includes an authentication tag (i.e. a message authentication code or message integrity code). Authenticating the received data packet may comprise performing one or more cryptographic processes using one or more portions of the data packet to generate an authentication tag, and checking this authentication tag against the authentication tag included in the data packet (i.e. verifying the authentication tag). If the tags match, authentication succeeds and, conversely, if the tags do not match, authentication fails. The authentication tag may be generated using cipher-block chaining (CBC). Correspondingly, authenticating the data packet may comprise performing cipher-block chaining operations to verify the authentication tag. Authenticating a payload of said packet that is M octets long requires ┌M/16┐+2 AES operations. In a set of embodiments the data packet is authenticated and encrypted using a counter with cipher block chaining message authentication code method, such as AES-CCM. In such embodiments it will be recognised that the client device omitting the authentication step saves ┌M/16┐+2 AES operations (i.e. over half of the AES operations required for decryption and authentication).

In a set of embodiments, the client device comprises one or more outputs for presenting information. For instance, the client device may comprise a display such as an electronic paper display. The client device may be arranged to output information based on one or more data structures received in an encrypted data packet. For instance, the client device may be arranged to output information contained in a data structure and/or to update currently output information in response to a command contained in a data structure. The client device may be arranged to output pricing information.

In a set of embodiments, the client device is battery powered. The client device may comprise a battery with a capacity of 20 Wh or less, 10 Wh or less, 5 Wh or less or 2 Wh or less. The present invention may be particularly beneficial for battery powered devices, where power savings and associated increases in battery life are typically highly desirable.

In a set of embodiments, the client device comprises an Electronic Shelf Label (ESL), i.e. arranged to display product information such as pricing information (e.g. of products on a shelf near to the ESL). The radio communication system may comprise an ESL system. In such embodiments the access point may comprise an ESL access point and/or the client devices may comprise ESLs.

In many implementations such as ESL systems, one-way communication to the client device may be sufficient for effective operation (e.g. because pricing information can simply be pushed to all relevant ESLs as needed). The client device may therefore comprise a radio receiver device that is not able to transmit its own radio signals. However, in some embodiments the client device comprises a radio transceiver device (i.e. able to transmit and receive radio signals). For instance, the client device may be arranged to transmit an acknowledgment of the data packet, e.g. to confirm to the access point that a data packet or structure has been received successfully. Additionally or alternatively, in a set of embodiments, the client device is arranged to transmit other data such as sensor data (e.g. to the access point and/or to another radio device).

The client device may comprise one or more sensors (e.g. a temperature sensor). The client device may be arranged to record and/or transmit data from one or more sensors (e.g. transmit said data to an access point). For instance, the client device may be positioned near to one or more products (e.g. to display pricing information regarding said product(s)) and be arranged to record and/or transmit temperature information, to allow a temperature of the products to be monitored.

It will be appreciated that the approach disclosed herein may be advantageously applied for a wide variety of radio signals and client device/access point hardware. The client device may comprise a frontend portion (e.g. an analogue frontend portion) arranged to receive and sample the radio signal, i.e. to produce a bit sequence corresponding to the data packet. The frontend portion may comprise one or more ADCs, mixers, filters, amplifiers and/or baluns. The client device may comprise a buffer in which the data packet is stored.

In a set of embodiments, the radio signal is a Bluetooth radio signal, e.g. a Bluetooth Low Energy (BLE) signal. The client device may be a Bluetooth device (e.g. a BLE device). The access point may be a Bluetooth device (e.g. a BLE device). The data packet may comprise a Bluetooth advertising packet.

The invention extends to computer software that, when executed by a client device, causes said client device to perform the method disclosed herein. The client device may comprise a memory storing said software. The client device may comprise a processor arranged to execute said software.

Features of any aspect or embodiment described herein may wherever appropriate, be applied to any other aspect or embodiment described herein. Where reference is made to different embodiments, it should be understood that these are not necessarily distinct but may overlap. It will be appreciated that all of the preferred features according to the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 is a schematic view of an Electronic Shelf Label (ESL) system according to an embodiment of the invention;

FIG. 2 is a schematic view of an ESL according to an embodiment of the invention;

FIG. 3 shows a data packet for use in embodiments of the invention; and

FIG. 4 is a flow diagram illustrating an embodiment of the invention.

### DETAILED DESCRIPTION

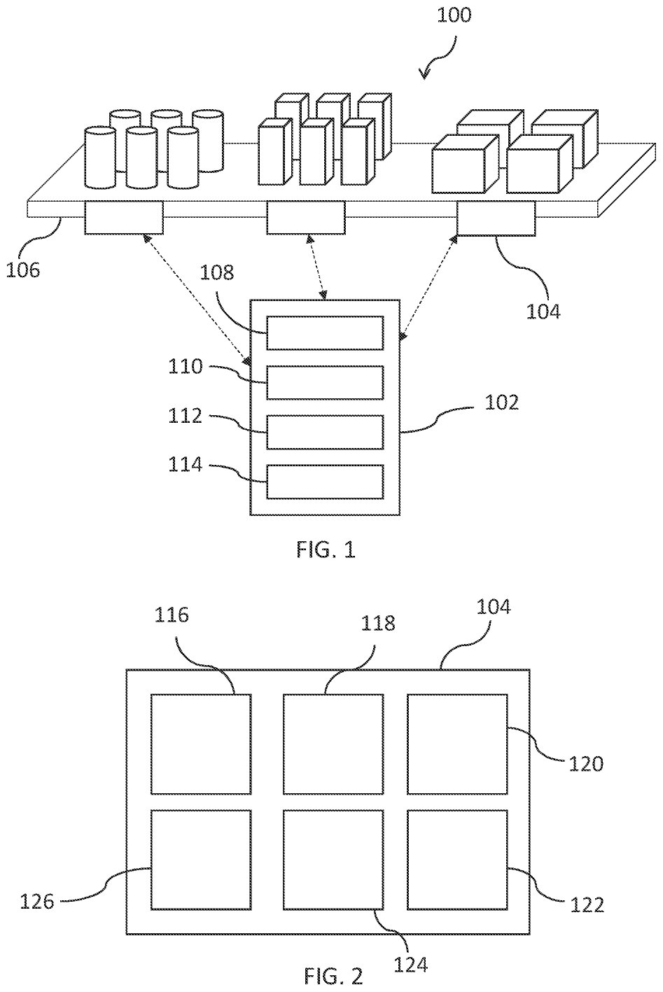

FIG. 1 shows an Electronic Shelf Label (ESL) system 100 comprising an Access Point (AP) 102 and a plurality of Electronic Shelf Labels (ESLs) 104. The ESLs 104 are mounted to a supermarket shelf 106 and indicate pricing information for respective goods on the shelf. Although FIG. 1 illustrates only one AP 102 and three ESLs 104, in practice the ESL system 100 may include multiple APs 102 and hundreds or thousands of ESLs 104.

The AP 102 comprises an antenna 108, an RF front-end portion 110, a processor 112 and a memory 114. FIG. 2 shows one of the ESLs 104 in more detail. Each ESL 104 comprises an electronic paper display 116 (which displays the pricing information), an antenna 118, an RF front-end portion 120, a processor 122, a memory 124 and a battery 126 which powers the ESL 104. The AP 102 may be battery-powered or may use an external source of power.

The AP 102 and the ESLs 104 form a radio communication network, operating according to the Bluetooth low-energy (BLE) protocol. The processor 112 of the AP 102 executes software stored on the memory 114 to control the front-end portion 110 to prepare and transmit radio signals using the antenna 108 (i.e. performing analogue transmission processes such as modulation and multiplexing). The AP 102 transmits advertising packets containing commands for one or more of the ESLs 104, e.g. to update pricing information displayed on a particular ESL 104.

Correspondingly, the processor 122 of each ESL 104 executes software stored on the memory 124 to control the front-end portion 120 to detect the radio signals from the AP 102, and to act on their contents (e.g. to update pricing information on the display 116) if appropriate.

To ensure secure communications (e.g. to prevent malicious changes of pricing information displayed on the ESLs 104), the AP 102 encrypts the advertising packets using an Advanced Encryption Standard-Counter with Cipher block Chaining Message authentication mode (AES-CCM) method. The AP 102 and the ESLs 104 share in advance a symmetric cryptographic key. The AP 102 uses this key to encrypt and authenticate the advertising packets, and the ESLs 104 use the same key to decrypt and authenticate the advertising packets. In practice, when AES-CCM encryption is used, the AP 102 and the ESLs 104 also share in advance an initialisation vector (IV) (or information for deriving the IV), and a correct key-IV pair is required for proper decryption and authentication of a given packet. However, the IV is omitted from this description for brevity and references to “a cryptographic key” may be understood to represent a key-IV pair.

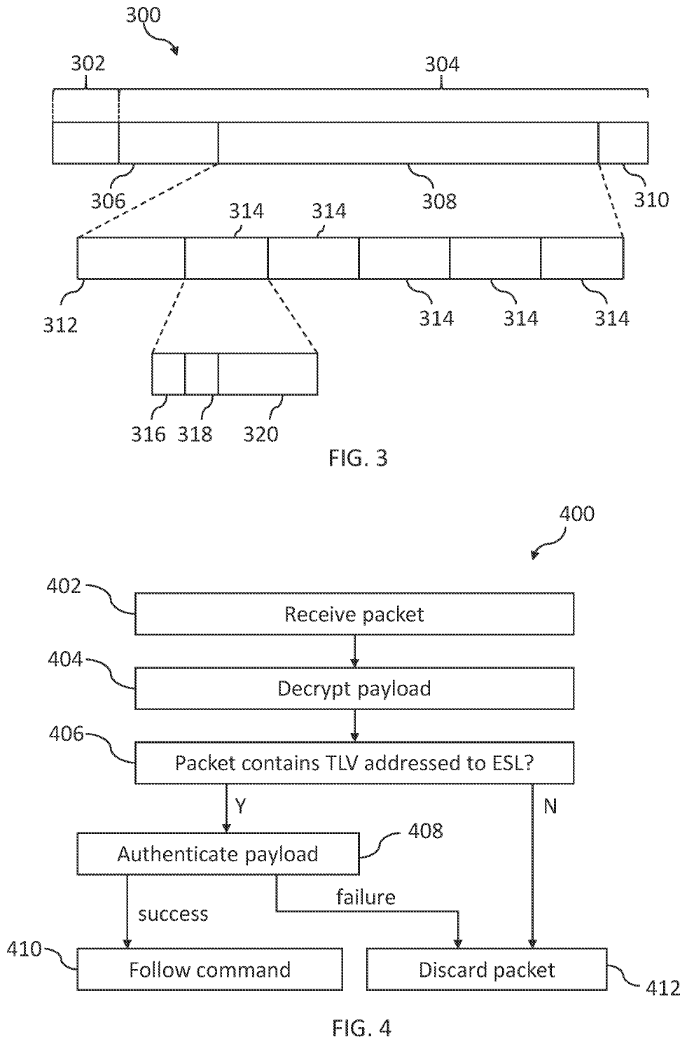

The structure of an advertising packet 300 is shown in detail in FIG. 3. Each advertising packet 300 comprises an unencrypted header portion 302 followed by an encrypted payload portion 304, encrypted and authenticated using 128-bit AES-CCM. The BLE specification permits advertising payloads of between 1 and 255 octets.

The payload portion 304 comprises some additional headers 306 (not illustrated in detail but including a field indicating the length of the payload portion 304, an encrypted data tag, a randomizer, a field indicating the length of the ESL payload, and an ESL tag), an ESL payload portion 308 and a message integrity code (MIC) 310. The ESL payload portion 308 in turn comprises a group ID field 312 (identifying a group of ESLs 104 to which the ESL payload portion 308 is addressed) followed by a plurality of TLV (Tag, Length, Value) structures 314. Each TLV structure 314 comprises a 4-bit tag field 316, a 4-bit length field 318 (which identifies the length of the TLV structure 314) and a value field 320. The first byte in the value field is an ESL_ID which identifies the ESL 104 to which the TLV structure 314 is addressed. The rest of the value field 320 contains the actual commands for the ESL 104 (e.g. updated pricing information). The ESL_ID may identify an individual ESL 104 or it may have a broadcast value indicating that the TLV 314 is addressed to all ESLs 104 in the group identified by the group ID field 312.

The operation of each ESL 104 will now be described in more detail with reference to the flow diagram 400 shown in FIG. 4.

In a first step 402, an ESL 104 receives an encrypted advertising packet 300 from the AP 102. In step 404 the ESL 104 decrypts the payload 304 using the pre-shared key. This requires ┌(L_{ESL}+2)/16┐ AES-128 operations, where L_{ESL} is the length of the ESL payload 308.

As explained above, the contents of the packet 300 must be authenticated (requiring additional AES-128 operations) before the ESL 104 can act on any commands contained therein, to ensure that only correct pricing information is displayed on the display 116. However, the ESL 104 does not immediately start to authenticate the payload 304. Instead, in step 406 the ESL 104 first inspects the group ID field 312 to see if it is in the group to which the ESL payload 308 (and the TLV structures 314 contained therein) is addressed. If the ESL 104 is in the group identified by the group ID field 312, it checks the ESL_ID of each of the TLV structures 314 to establish if any of the TLV structures 314 is addressed to the ESL 104.

If any of the TLV structures 314 is addressed to the ESL 104, the ESL 104 proceeds to authenticate the payload 304 in step 408. Authentication involves a further ┌(L_{ESL}+2)/16┐+2 AES-128 operations.

If authentication succeeds, the ESL 104 proceeds in step 410 to process the TLV structure(s) 314 addressed to the ESL 104, e.g. to update pricing information as commanded. If authentication fails, the ESL 104 discards the packet with no or only minimal further processing in step 412. The ESL 104 thus only acts on commands whose integrity has been verified with authentication.

However, if the ESL 104 is not in the group identified by the group ID field 312, or none of the TLV structures 314 is addressed to the ESL 104, the ESL 104 moves directly to step 412 and discards the packet with no or only minimal further processing in step 412. Because the packet 300 is discarded without the ESL 104 authenticating the payload 304, ┌(L_{ESL}+2)/16┐+2 AES-128 operations are avoided (i.e. over half of the total number of operations needed to decrypt and authenticate).

Thus, in comparison to a conventional approach in which all packets are decrypted and authenticated, by being more selective over the use of authentication the ESL 104 can make significant energy savings whilst still reliably acting on authenticated commands.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of operating a client device, the method comprising:
receiving a radio signal comprising an encrypted data packet, said data packet comprising one or more data structures addressed to one or more client devices;
decrypting said data packet to obtain said one or more data structures;
establishing whether any of the one or more data structures is addressed to the client device; and
if a data structure of the data packet is addressed to the client device, authenticating the data packet; and
if no data structure of the data packet is addressed to the client device, discarding the data packet.

2. The method of claim 1, wherein the data packet comprises a plurality of data structures addressed to a corresponding plurality of client devices.

3. The method of claim 1, comprising, if authentication of the data packet succeeds, the client device following one or more commands contained in a data structure of the data packet.

4. The method of claim 1, comprising, if authentication of the data packet fails, discarding the data packet.

5. The method of claim 1, wherein each data structure includes address information which identifies one or more client devices to which said data structure is addressed and establishing whether any of the one or more data structures is addressed to the client device comprises the client device comparing the address information of each data structure in the data packet to address information of the client device.

6. The method of claim 1, wherein the data packet includes group address information which identifies a group of client devices to which data structure(s) of the data packet are addressed, and the method comprises discarding the packet immediately if the client device does not belong to the identified group.

7. The method of claim 1, wherein the data packet is encrypted using symmetric encryption.

8. The method of claim 1, wherein the data packet comprises an authentication tag generated using cipher-block chaining and authenticating the data packet comprises performing cipher-block chaining operations to verify the authentication tag.

9. The method of claim 1, wherein the data packet is authenticated and encrypted using a counter with cipher block chaining message authentication code method, such as AES-CCM.

10. The method of claim 1, comprising the client device outputting information based on one or more data structures received in an encrypted data packet.

11. The method of claim 1, comprising the client device outputting pricing information.

12. The method of claim 1, wherein the client device comprises a display.

13. The method of claim 1, wherein the client device is battery powered.

14. The method of claim 1, wherein the client device comprises an Electronic Shelf Label.

15. The method of claim 1, comprising the client device recording and/or transmitting data from one or more sensors.

16. The method of any claim 1, wherein the client device is a Bluetooth device.

17. A client device arranged to:
receive a radio signal comprising an encrypted data packet, said data packet comprising one or more data structures addressed to one or more client devices;
decrypt said data packet to obtain said one or more data structures;
establish whether any of the one or more data structures is addressed to the client device; and
if a data structure of the data packet is addressed to the client device, authenticate the data packet; and
if no data structure of the data packet is addressed to the client device, discard the data packet.

18. The client device of claim 17, wherein the data packet comprises a plurality of data structures addressed to a corresponding plurality of client devices.

19. A radio communication system comprising:
a plurality of client devices; and
an access point arranged to transmit a radio signal comprising an encrypted data packet, said data packet comprising one or more data structures addressed to one or more of the plurality of client devices;
wherein each of the plurality of client devices is arranged to:
receive the radio signal comprising the encrypted data packet from the access point;
decrypt said data packet to obtain said one or more data structures;
establish whether any of the one or more data structures is addressed to the client device; and
if a data structure of the data packet is addressed to the client device, authenticate the data packet; and
if no data structure of the data packet is addressed to the client device, discard the data packet.

20. The radio communication system of claim 19, comprising an Electronic Shelf Label system in which the access point comprises an Electronic Shelf Label access point and the client devices comprise Electronic Shelf Labels.
